(19) United States
(12) Patent Application Publication
(10) Pub. No.: US 2024/0071647 A1
(43) Pub. Date: Feb. 29, 2024

(54) COMPOSITION

(71) Applicant: BOREALIS AG, Vienna (AT)

(72) Inventors: Per-Ola HAGSTRAND, Stenungsund (SE); Thomas GKOURMPIS, Stenungsund (SE); Christian MÜLLER, Göteborg (SE); Yingwei OUYANG, Göteborg (SE)

(21) Appl. No.: 18/271,322

(22) PCT Filed: Jan. 10, 2022
(86) PCT No.: PCT/EP2022/050324

§ 371 Date: Jul. 7, 2023

(30) Foreign Application Priority Data
Jan. 8, 2021 (EP) 21150784.3

(51) Int. Cl. H01B 3/44; C08L 23/06

(52) U.S. Cl. CPC H01B 3/441; C08L 23/06; C08L 2203/202; C08L 2205/025; C08L 2205/03; C08L 2207/062; C08L 2207/066; C08L 2207/10

(57) ABSTRACT

The invention provides a polymer composition comprising (i) 25 to 84 wt % LDPE; (ii) 15 to 74 wt % of a polypropylene; and (iii) 1.0 to 20 wt % of a polyolefin (A) selected from the group consisting of a linear low density polyethylene (LLDPE), high density polyethylene (HDPE), polystyrene and polybutadiene.

This invention relates to polymer compositions which comprise a low density polyethylene (LDPE), a polypropylene and a polyolefin (A) selected from the group consisting of a linear low density polyethylene (LLDPE), high density polyethylene (HDPE), polystyrene and polybutadiene. In particular, the compositions of the invention offer the possibility to obtain a polymer composition which is suitable for use in cable applications without the use of peroxide. The invention also relates to cables comprising the compositions and processes for preparing such cables.

### BACKGROUND

Polyolefins produced in a high pressure (HP) process are widely used in demanding polymer applications where the polymers must meet high mechanical and/or electrical requirements. For instance in power cable applications, particularly in medium voltage (MV) and especially in high voltage (HV) and extra high voltage (EHV) cable applications, the electrical properties of the polymer composition used in the cable have significant importance.

Furthermore, the mechanical properties of the polymer composition, in particular when subjected to heat in cable applications, are of particular significance. In HV DC cables, the insulation is partly heated by the leakage current. For a specific cable design the leakage current heating is proportional to the insulation conductivity×(electrical field)². Thus, if the voltage is increased, far more heat will be generated. It is important that the dimensional stability of the polymer do not significantly deteriorate in the presence of this heat.

A typical power cable comprises a conductor surrounded, at least, by an inner semiconductive layer, an insulation layer and an outer semiconductive layer, in that order. The cables are commonly produced by extruding the layers on a conductor.

The polymer material in one or more of said layers is often crosslinked to improve e.g. heat and deformation resistance, creep properties, mechanical strength, chemical resistance and abrasion resistance. During the crosslinking reaction, crosslinks (bridges) are primarily formed. Crosslinking can be effected using e.g. a free radical generating compound which is typically incorporated into the layer material prior to the extrusion of the layer(s) on a conductor. After formation of the layered cable, the cable is then subjected to a crosslinking step to initiate the radical formation and thereby crosslinking reaction.

Peroxides are very commonly used as free radical generating compounds. Crosslinking using peroxides suffers from some disadvantages, however. For example low-molecular by-products are formed during crosslinking which have an unpleasant odour. These decomposition products of peroxides may include volatile by-products which are often undesired, since they may have a negative influence on the electrical properties of the cable. Therefore the volatile decomposition products such as methane are conventionally reduced to a minimum or removed after crosslinking and a cooling step. Such a removal step, generally known as a degassing step, is time and energy consuming causing extra costs.

Thermoplastic LDPE can offer several advantages compared to a thermosetting cross-linked PE, such as no possibility of peroxide initiated scorch and no degassing step is required to remove peroxide decomposition products. The elimination of crosslinking and degassing steps can lead to faster, less complicated and more cost effective cable production. The absence of peroxide at high temperature vulcanisation is also attractive from a health & safety perspective. Thermoplastics are also beneficial from a recycling point of view. However, the absence of a cross-links can lead to a reduced dimensional stability at elevated temperatures.

Thus, there is a need for new polyolefin compositions which avoid the disadvantages associated with peroxides, but which also offer attractive thermomechanical properties. Hence, it is the object of the present invention to provide a new polyolefin composition which can provide such properties suitable for use in cable applications without using peroxide at all.

The possibility of using non cross-linked LDPE in the insulation layer of a cable is not new. In WO2011/113685, LDPE of density 922 kg/m³ and MFR₂ 1.90 g/10 min is suggested for use in the insulation layer of a cable. WO2011/113685 also suggests using other polymers individually in the non cross-linked insulation layer of a cable.

WO2017/220608 describes the combination of LDPE and HDPE or an ultra-high molecular weight polyethylene having a Mw of at least 1,000,000 in the insulation layer of a cable.

WO2017/220616 describes the combination of low density polyethylene (LDPE); and a conjugated aromatic polymer in the insulation layer of a cable.

The combination of an LDPE with two polyolefins: one comprising epoxy groups and the other comprising carboxylic acid groups, or precursors thereof is discussed in WO2020/229658 and WO2020/229659.

WO2020/229657 describes a polyolefin composition comprising a polyolefin (A) comprising epoxy groups and a polyolefin (B) comprising carboxylic acid groups and/or precursors thereof, with the proviso that one of polyolefin (A) and polyolefin (B) is a low density polyethylene (LDPE) and the other of polyolefin (A) and polyolefin (B) is a polypropylene.

The present inventors have now found that the combination of a LDPE and a polypropylene with polyolefin selected from the group consisting of a linear low density polyethylene (LLDPE), high density polyethylene (HDPE), polystyrene and polybutadiene provides a composition which is ideally suited for cable manufacture and advantageously does not require the use of peroxide. Surprisingly, these blends have much more attractive storage modulus than the corresponding LDPE/PP blend. Hence it is demonstrated that the blends of the invention can be used in cable layers without the need for a crosslinking reaction to make the layer thermosetting.

Without wishing to be bound by any theory, it is believed that the polyolefin (A) provides a compatibilization effect between the LDPE and the polypropylene. This effect may occur at temperatures typical for formulation preparation, such as compounding by, for example, extrusion.

### SUMMARY OF INVENTION

Thus, viewed from one aspect the invention provides a polymer composition comprising
(i) 25 to 84 wt % LDPE;
(ii) 15 to 74 wt % of a polypropylene; and
(iii) 1.0 to 20 wt % of a polyolefin (A) selected from the group consisting of a linear low density polyethylene (LLDPE), high density polyethylene (HDPE), polystyrene and polybutadiene.

It will be appreciated that the weight percent ranges in the embodiment above are based on the weight of the component in question in the polymer composition as a whole.

Viewed from another aspect, the invention provides a cable, such as a power cable comprising one or more conductors surrounded by at least one layer, wherein said layer comprises a polymer composition as hereinbefore defined.

Viewing from a further aspect, the invention provides a process for the preparation of a polymer composition as hereinbefore defined comprising compounding:
(i) 25 to 84 wt % LDPE;
(ii) 15 to 74 wt % of a polypropylene; and
(iii) 1.0 to 20 wt % of a polyolefin (A) selected from the group consisting of a linear low density polyethylene (LLDPE), high density polyethylene (HDPE), polystyrene and polybutadiene.

The invention also provides a process for producing a cable comprising the steps of: applying on one or more conductors, a layer comprising a polymer composition as hereinbefore defined.

Viewed from one aspect the invention provides the use of a polymer composition as hereinbefore defined in the manufacture of an insulation layer in a cable, preferably a power cable.

### Definitions

Wherever the term “molecular weight Mw” is used herein, the weight average molecular weight is meant.

The term “polyethylene” will be understood to mean an ethylene based polymer, i.e. one comprising at least 50 wt % ethylene, based on the total weight of the polymer as a whole. The terms “polyethylene” and “ethylene-based polymer,” are used interchangeably herein, and men a polymer that comprises a majority weight percent polymerized ethylene monomer (based on the total weight of polymerisable monomers), and optionally may comprise at least one polymerised comonomer. The ethylene-based polymer may include greater than 50, or greater than 60, or greater than 70, or greater than 80, or greater than 90 weight percent units derived from ethylene (based on the total weight of the ethylene-based polymer).

The term “polypropylene” will be understood to mean a propylene based polymer, i.e. one comprising at least 50 wt % propylene, based on the total weight of the polymer as a whole.

Non cross-linked polymer compositions or cable layers are regarded as thermoplastic.

The polymer composition of the invention may also be referred to as a polymer blend herein. These terms are used interchangeably.

The low density polyethylene, LDPE, of the invention is a polyethylene produced in a high pressure process. Typically the polymerization of ethylene and optional further comonomer(s) in a high pressure process is carried out in the presence of an initiator(s). The meaning of the term LDPE is well known and documented in the literature. The term LDPE describes and distinguishes a high pressure polyethylene from low pressure polyethylenes produced in the presence of an olefin polymerisation catalyst. LDPEs have certain typical features, such as different branching architecture. A typical density range for an LDPE is 0.910 to 0.940 g/cm 3.

The term “conductor” means herein a conductor comprising one or more wires. The wire can be for any use and be e.g. optical, telecommunication or electrical wire. Moreover, the cable may comprise one or more such conductors. Preferably the conductor is an electrical conductor and comprises one or more metal wires.

### DETAILED DESCRIPTION OF THE INVENTION

The present invention relates to a particular polymer composition comprising (i) an LDPE, (ii) a polypropylene, (iii) a polyolefin (A) selected from the group consisting of a linear low density polyethylene (LLDPE), high density polyethylene (HDPE), polystyrene and polybutadiene

Generally, the compatibility between polyethylene and polypropylene is relatively low. Blends between these polymers therefore typically result in phase separated systems. However, the a polyolefin (A) is able to act as a compatibiliser. It reduces phase separation, and results in blends with advantageous thermomechanical properties, e.g. in terms of storage modulus. The higher thermomechanical performance of the invention may allow higher operating temperature of power cables, which in principle can allow higher transmission capacity.

### LDPE

The low density polyethylene (LDPE) is an ethylene-based polymer. The term, “ethylene-based polymer,” as used herein, is a polymer that comprises a majority weight percent polymerized ethylene monomer (based on the total weight of polymerisable monomers), and optionally may comprise at least one polymerised comonomer. The ethylene-based polymer may include greater than 50, or greater than 60, or greater than 70, or greater than 80, or greater than 90 weight percent units derived from ethylene (based on the total weight of the ethylene-based polymer).

The LDPE may be a low density homopolymer of ethylene (referred herein as LDPE homopolymer) or a low density copolymer of ethylene with one or more comonomer(s) (referred herein as LDPE copolymer). The one or more comonomers of the LDPE copolymer are preferably selected from the polar comonomer(s), non-polar comonomer(s) or from a mixture of the polar comonomer(s) and non-polar comonomer(s). Moreover, said LDPE homopolymer or LDPE copolymer may optionally be unsaturated. Preferably, the LDPE is a homopolymer.

As a polar comonomer for the LDPE copolymer comonomer(s) containing hydroxyl group(s), alkoxy group(s), carbonyl group(s), carboxyl group(s), ether group(s) or ester group(s), or a mixture thereof, can be used. More preferably, comonomer(s) containing carboxyl and/or ester group(s) are used as said polar comonomer. Still more preferably, the polar comonomer(s) of the LDPE copolymer is selected from the groups of acrylate(s), methacrylate(s) or acetate(s), or any mixtures thereof.

If present in said LDPE copolymer, the polar comonomer(s) is preferably selected from the group of alkyl acrylates, alkyl methacrylates or vinyl acetate, or a mixture thereof. Further preferably, said polar comonomers are selected from C₁- to C₆-alkyl acrylates, C₁- to C₆-alkyl methacrylates or vinyl acetate. Still more preferably, said polyolefin (A) copolymer is a copolymer of ethylene with C₁- to C₄-alkyl acrylate, such as methyl, ethyl, propyl or butyl acrylate, or vinyl acetate, or any mixture thereof.

As the non-polar comonomer(s) for the LDPE copolymer, comonomer(s) other than the above defined polar comonomers can be used. Preferably, the non-polar comonomers are other than comonomer(s) containing hydroxyl group(s), alkoxy group(s), carbonyl group(s), carboxyl group(s), ether group(s) or ester group(s). One group of preferable non-polar comonomer(s) comprise, preferably consist of, monounsaturated (=one double bond) comonomer(s), preferably olefins, preferably alpha-olefins, more preferably C₃ to C₁₀ alpha-olefins, such as propylene, 1-butene, 1-hexene, 4-methyl-1-pentene, styrene, 1-octene, 1-nonene; polyunsaturated (=more than one double bond) comonomer(s); a silane group containing comonomer(s); or any mixtures thereof. The polyunsaturated comonomer(s) are further described below in relation to unsaturated LDPE copolymers.

If the LDPE is a copolymer, it preferably comprises 0.001 to 35 wt.-%, still more preferably less than 30 wt.-%, more preferably less than 25 wt.-%, of one or more comonomer(s). Preferred ranges include 0.5 to 10 wt %, such as 0.5 to 5 wt % comonomer.

The LDPE polymer, may optionally be unsaturated, i.e. may comprise carbon-carbon double bonds (—C═C—). Preferred “unsaturated” LDPEs contains carbon-carbon double bonds/1000 carbon atoms in a total amount of at least 0.4/1000 carbon atoms. If a non-cross-linked LDPE is used in the final cable, then the LDPE is typically not unsaturated as defined above. By not unsaturated is meant that the C═C content is preferably less than 0.2/1000 carbon atoms, such as 0.1/1000 C atoms or less.

As well known, the unsaturation can be provided to the LDPE polymer by means of the comonomers, a low molecular weight (Mw) additive compound, such as a CTA or scorch retarder additive, or any combinations thereof. The total amount of double bonds means herein double bonds added by any means. If two or more above sources of double bonds are chosen to be used for providing the unsaturation, then the total amount of double bonds in the LDPE polymer means the sum of the double bonds present. Any double bond measurements are carried out prior to optional crosslinking.

The term “total amount of carbon-carbon double bonds” refers to the combined amount of double bonds which originate from vinyl groups, vinylidene groups and trans-vinylene groups, if present.

If an LDPE homopolymer is unsaturated, then the unsaturation can be provided e.g. by a chain transfer agent (CTA), such as propylene, and/or by polymerization conditions. If an LDPE copolymer is unsaturated, then the unsaturation can be provided by one or more of the following means: by a chain transfer agent (CTA), by one or more polyunsaturated comonomer(s) or by polymerisation conditions. It is well known that selected polymerisation conditions such as peak temperatures and pressure, can have an influence on the unsaturation level. In case of an unsaturated LDPE copolymer, it is preferably an unsaturated LDPE copolymer of ethylene with at least one polyunsaturated comonomer, and optionally with other comonomer(s), such as polar comonomer(s) which is preferably selected from acrylate or acetate comonomer(s). More preferably an unsaturated LDPE copolymer is an unsaturated LDPE copolymer of ethylene with at least polyunsaturated comonomer(s).

The polyunsaturated comonomers suitable as the non polar comonomer preferably consist of a straight carbon chain with at least 8 carbon atoms and at least 4 carbons between the non-conjugated double bonds, of which at least one is terminal, more preferably, said polyunsaturated comonomer is a diene, preferably a diene which comprises at least eight carbon atoms, the first carbon-carbon double bond being terminal and the second carbon-carbon double bond being non-conjugated to the first one. Preferred dienes are selected from C₈ to C₁₄ non-conjugated dienes or mixtures thereof, more preferably selected from 1,7-octadiene, 1,9-decadiene, 1,11-dodecadiene, 1,13-tetradecadiene, 7-methyl-1,6-octadiene, 9-methyl-1,8-decadiene, or mixtures thereof. Even more preferably, the diene is selected from 1,7-octadiene, 1,9-decadiene, 1,11-dodecadiene, 1,13-tetradecadiene, or any mixture thereof, however, without limiting to above dienes.

It is well known that e.g. propylene can be used as a comonomer or as a chain transfer agent (CTA), or both, whereby it can contribute to the total amount of the carbon-carbon double bonds, preferably to the total amount of the vinyl groups. Herein, when a compound which can also act as comonomer, such as propylene, is used as CTA for providing double bonds, then said copolymerisable comonomer is not calculated to the comonomer content.

If LDPE polymer is unsaturated, then it has preferably a total amount of carbon-carbon double bonds, which originate from vinyl groups, vinylidene groups and trans-vinylene groups, if present, of more than 0.4/1000 carbon atoms, preferably of more than 0.5/1000 carbon atoms. The upper limit of the amount of carbon-carbon double bonds present in the polyolefin is not limited and may preferably be less than 5.0/1000 carbon atoms, preferably less than 3.0/1000 carbon atoms.

If the LDPE is unsaturated LDPE as defined above, it contains preferably at least vinyl groups and the total amount of vinyl groups is preferably higher than 0.05/1000 carbon atoms, still more preferably higher than 0.08/1000 carbon atoms, and most preferably of higher than 0.11/1000 carbon atoms. Preferably, the total amount of vinyl groups is of lower than 4.0/1000 carbon atoms, more preferably lower than 2.0/1000 carbon atms. More preferably the LDPE contains vinyl groups in total amount of more than 0.20/1000 carbon atoms, still more preferably of more than 0.30/1000 carbon atoms.

It is however, preferred if the LDPE of the invention is not unsaturated and possesses less than 0.2 C═C/1000 C atoms, preferably less than 0.1 C═C/1000 C atoms. It is also preferred if the LDPE is a homopolymer. As the polymer composition of the invention is not designed for crosslinking, the presence of unsaturation within the LDPE is not required or desired.

The LDPE polymer may have a high melting point, which may be of importance especially for a thermoplastic insulation material. Melting points of 112° C. or more are envisaged, such as 114° C. or more, especially 116° C. or more, such as 112 to 130° C.

The LDPE used in the composition of the invention may have a density of 915 to 940 kg/m³, preferably 918 to 935 kg/m³, especially 920 to 932 kg/m³, such as about 922 to 930 kg/m³.

The MFR 2 (2.16 kg, 190° C.) of the LDPE polymer is preferably from 0.05 to 30.0 g/10 min, more preferably is from 0.1 to 20 g/10 min, and most preferably is from 0.1 to 10 g/10 min, especially 0.1 to 5.0 g/10 min. In a preferred embodiment, the MFR₂ of the LDPE is 0.1 to 4.0 g/10 min, especially 0.5 to 4.0 g/10 min, especially 1.0 to 3.0 g/10 min.

The LDPE may have an Mw of 80 kg/mol to 200 kg/mol, such as 100 to 180 kg/mol.

The LDPE may have a PDI of 5 to 15, such as 8 to 14.

It is possible to use a mixture of LDPEs in the polymer composition of the invention however it is preferred if a single LDPE is used. If a mixture of LDPEs is used then the wt % quoted refer to the total LDPE content present.

The LDPE polymer is produced at high pressure by free radical initiated polymerisation (referred to as high pressure (HP) radical polymerization). The HP reactor can be e.g. a well-known tubular or autoclave reactor or a mixture thereof, preferably a tubular reactor. The high pressure (HP) polymerisation and the adjustment of process conditions for further tailoring the other properties of the polyolefin depending on the desired end application are well known and described in the literature, and can readily be used by a skilled person. Suitable polymerisation temperatures range up to 400° C., preferably from 80 to 350° C. and pressure from 70 MPa, preferably 100 to 400 MPa, more preferably from 100 to 350 MPa. Pressure can be measured at least after compression stage and/or after the tubular reactor. Temperature can be measured at several points during all steps.

After the separation the obtained LDPE is typically in a form of a polymer melt which is normally mixed and pelletized in a pelletising section, such as pelletising extruder, arranged in connection to the HP reactor system. Optionally, additive(s), such as antioxidant(s), can be added in this mixer in a known manner.

Further details of the production of ethylene (co)polymers by high pressure radical polymerization can be found i.a. in the Encyclopedia of Polymer Science and Engineering, Vol. 6 (1986), pp 383-410 and Encyclopedia of Materials: Science and Technology, 2001 Elsevier Science Ltd.: “Polyethylene: High-pressure, R. Klimesch, D. Littmann and F.-O. Mähling pp. 7181-7184.

It is most preferred if the LDPE is a low density homopolymer of ethylene.

The LDPE (i) is present in an amount of 25 to 84 wt %, preferably 25 to 75 wt %, more preferably 50 to 75 wt %, even more preferably 60 to 74 wt %, such as 65 to 73 wt % relative to the total weight of the composition as a whole.

The LDPE of the invention is not new. For example, Borealis grade LE6222 is suitable for use in the present invention.

### Polypropylene

The polypropylene is a propylene based polymer. The term, “propylene-based polymer,” as used herein, is a polymer that comprises a majority weight percent polymerized propylene monomer (based on the total weight of polymerisable monomers), and optionally may comprise at least one polymerised comonomer. The propylene-based polymer may include greater than 50, or greater than 60, or greater than 70, or greater than 80, or greater than 90 weight percent units derived from propylene (based on the total weight of the propylene-based polymer).

The polypropylene may be a propylene homopolymer or a propylene copolymer. Preferably, the polypropylene is a homopolymer.

The comonomer may be α-olefin such as ethylene or a C₄-20 linear, branched or cyclic α-olefin. Nonlimiting examples of suitable C₃-20 α-olefins include 1-butene, 4-methyl-1-pentene, 1-hexene, 1-octene, 1-decene, 1-dodecene, 1-tetradecene, 1-hexadecene, and 1-octadecene. The α-olefins also can contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, for purposes of this disclosure certain cyclic olefins, such as norbornene and related olefins, particularly 5-ethylidene-2-norbornene, are α-olefins and can be used in place of some or all of the α-olefins described above. Similarly, styrene and its related olefins (for example, α-methylstyrene, etc.) are α-olefins for purposes of this disclosure. Illustrative propylene polymers include ethylene/propylene, propylene/butene, propylene/1-hexene, propylene/1-octene, propylene/styrene, and the like. Illustrative terpolymers include ethylene/propylene/1-octene, ethylene/propylene/butene, propylene/butene/1-octene, ethylene/propylene/diene monomer (EPDM) and propylene/butene/styrene. The copolymers can be random copolymers.

In a particularly preferred embodiment, the polypropylene is an isotactic propylene homopolymer.

Whilst not wishing to be bound by theory, the use of isotactic propylene homopolymer provides a lower conductivity, due to the specific process in which it is produced resulting in an exceptionally clean grade product.

Typically, the polypropylene has an MFR 2 of from 0.1 to 100 g/10 min, preferably from 0.5 to 50 g/10 min as determined in accordance with ISO 1133 (at 230° C.; 2.16 kg load). Most preferably, the MFR is in the range of 1.0 to 5.0 g/10 min, such as 1.5 to 4.0 g/10 min.

The density of the polypropylene may typically be in the range 890 to 940 kg/m³, ideally 0.895 to 0.920 g/cm 3, preferably from 0.900 to 0.915 g/cm 3, and more preferably from 0.905 to 0.915 g/cm 3 as determined in accordance with ISO 1183.

The propylene may have an Mw in the range of 200 kg/mol to 600 kg/mol. The polypropylene polymer preferably has a molecular weight distribution Mw/Mn, being the ratio of the weight average molecular weight Mw and the number average molecular weight Mn, of less than 4.5, such as 2.0 to 4.0, e.g. 3.0.

Usually the melting temperature of the polypropylene is within the range of 135 to 170° C., preferably in the range of 140 to 168° C., more preferably in the range from 142 to 166° C. as determined by differential scanning calorimetry (DSC) according to ISO 11357-3. Ideally, the polypropylene has a melting temperature (Tm) of greater than 140° C., preferably greater than 150° C.

The polypropylene may be prepared by any suitable known method in the art or can be obtained commercially.

It is possible to use a mixture of polypropylenes in the polymer composition of the invention however it is preferred if a single polypropylene is used. If a mixture of polypropylenes is used then the wt % quoted refer to the total polypropylene content present.

The polypropylene (ii) is present in an amount of 15 to 74 wt %, preferably 20 to 70 wt %, more preferably 20 to 50 wt %, even more preferably 22 to 40 wt %, such as 23 to 35 wt % relative to the total weight of the composition as a whole.

These polymers are readily available from polymer suppliers.

### Polyolefin (A)

The polyolefin (A) is selected from the group consisting of a linear low density polyethylene (LLDPE), high density polyethylene (HDPE), polystyrene and polybutadiene. Preferably, the polyolefin (A) is an LLDPE.

The polyolefin (A) (iii) is present in an amount of 1.0 to 20 wt %, preferably 1.0 to 15 wt %, more preferably 2.0 to 10 wt %, even more preferably 3.0 to 8 wt %, such as 5 wt % relative to the total weight of the composition as a whole.

### Linear Low Density Polyethylene (LLDPE)

The LLDPE may have a density according to ISO 1183 at 23° C. of 910 kg/m³ to 925 kg/m³. Ideally the polymer will have a density of at least 912 kg/m³. A preferred density range may be 912-922 kg/m³, especially 915 to 921 kg/m³. This density is made possible by the single-site catalysed polymerisation of the ethylene polymer and has several advantages.

The LLDPE preferably has a MFR 21 of 5-50 g/10 min, more preferably 10 to 40 g/10 min, especially 20 to 35 g/10 min. MFR 2 values may range from 0.1 to 10.0 g/10 min, such as 0.5 to 5 g/10 min. Ideally the MFR 2 value is in the range 0.5 to 3 g/10 min. The LLDPE preferably has a molecular weight, Mw, of at least 80,000, preferably at least 100,000. Very high Mw is not favoured. Mw should not be greater than 250,000, e.g. no more than 200,000. The Mw/Mn is dependent on modality but may range from 2 to 12, such as 2 to 10, e.g. 2 to 5.

The LLDPE may be unimodal or multimodal. The term “multimodal” means herein, unless otherwise stated, multimodality with respect to molecular weight distribution and includes therefore a bimodal polymer. Usually, a polyethylene composition, comprising at least two polyethylene fractions, which have been produced under different polymerization conditions resulting in different (weight average) molecular weights and molecular weight distributions for the fractions, is referred to as “multimodal”. The prefix “multi” relates to the number of different polymer fractions present in the polymer. Thus, for example, multimodal polymer includes so called “bimodal” polymer consisting of two fractions. The form of the molecular weight distribution curve, i.e. the appearance of the graph of the polymer weight fraction as a function of its molecular weight, of a multimodal polymer will show two or more maxima or is typically distinctly broadened in comparison with the curves for the individual fractions. For example, if a polymer is produced in a sequential multistage process, utilizing reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions form typically together a broadened molecular weight distribution curve for the total resulting polymer product.

A unimodal polymer, unless otherwise stated, is unimodal with respect to molecular weight distribution and therefore contains a single peak on is GPC curve.

The LLDPE may be a homopolymer or a copolymer, preferably a copolymer.

When the LLDPE is a copolymer it is formed from ethylene with at least one other comonomer, e.g. C₃-20 olefin. Preferred comonomers are alpha-olefins, especially with 3-8 carbon atoms. Preferably, the comonomer is selected from the group consisting of propene, 1-butene, 1-hexene, 4-methyl-1-pentene, 1-octene, 1,7-octadiene and 7-methyl-1,6-octadiene. The use of 1-hexene and/or 1-butene is most preferred.

The polymer can comprise one monomer or two monomers or more than 2 monomers. The use of a single comonomer is preferred. If two comonomers are used it is preferred if one is an C₃-8 alpha-olefin and the other is a diene as hereinbefore defined.

The amount of comonomer is preferably such that it comprises 0-3 mol %, more preferably 0.5-3.0 mol % of the LLDPE. Values under 1.0 mol % are also envisaged, e.g. 0.1 to 1.0 mol %. These can be determined by NMR.

The LLDPE may be prepared by single-site catalysed polymerisation or Ziegler-Natta catalysed polymerisation. The use of a single-site catalysed LLDPE is preferred. The LLDPE as defined above may be made using any conventional single site catalysts, including metallocenes and non-metallocenes as well known in the field.

Preferably said catalyst is one comprising a metal coordinated by one or more η-bonding ligands. Such η-bonded metals are typically transition metals of Group 3 to 10, e.g. Zr, Hf or Ti, especially Zr or Hf. The η-bonding ligand is typically an η⁵-cyclic ligand, i.e. a homo or heterocyclic cyclopentadienyl group optionally with fused or pendant substituents. Such single site, preferably metallocene, procatalysts have been widely described in the scientific and patent literature for about twenty years. Procatalyst refers herein to said transition metal complex.

The metallocene procatalyst may have a formula II:

(Cp)ₘRₙMX_{q} (II)

wherein:
each Cp independently is an unsubstituted or substituted and/or fused homo- or heterocyclopentadienyl ligand, e.g. substituted or unsubstituted cyclopentadienyl, substituted or unsubstituted indenyl or substituted or unsubstituted fluorenyl ligand;
the optional one or more substituent(s) being independently selected preferably from halogen, hydrocarbyl (e.g. C₁-C₂₀-alkyl, C₂-C₂₀-alkenyl, C₂-C₂₀-alkynyl, C₃-C₁₂-cycloalkyl, C₆-C₂₀-aryl or C₇-C₂₀-arylalkyl), C₃-C₁₂-cycloalkyl which contains 1, 2, 3 or 4 heteroatom(s) in the ring moiety, C₆-C₂₀-heteroaryl, C₁-C₂₀-haloalkyl, —SiR″₃, —OSiR″₃, —SR″, —PR″₂ or —NR″₂,
each R″ is independently a hydrogen or hydrocarbyl, e.g. C₁-C₂₀-alkyl, C₂-C₂₀-alkenyl, C₂-C₂₀-alkynyl, C₃-C₁₂-cycloalkyl or C₆-C₂₀-aryl; or e.g. in case of —NR″₂, the two substituents R″ can form a ring, e.g. five- or six-membered ring, together with the nitrogen atom to which they are attached;
R is a bridge of 1-7 atoms, e.g. a bridge of 1-4 C-atoms and 0-4 heteroatoms, wherein the heteroatom(s) can be e.g. Si, Ge and/or O atom(s), wherein each of the bridge atoms may bear independently substituents, such as C₁₋₂₀-alkyl, tri(C₁₋₂₀-alkyl)siloxy or C₆₋₂₀-aryl substituents); or a bridge of 1-3, e.g. one or two, hetero atoms, such as silicon, germanium and/or oxygen atom(s), e.g. —SiR¹₂—, wherein each R¹ is independently C₁₋₂₀-alkyl, C₆₋₂₀-aryl or tri(C₁₋₂₀-alkyl)silyl-residue, such as trimethylsilyl;
M is a transition metal of Group 3 to 10, preferably of Group 4 to 6, such as Group 4, e.g. Ti, Zr or Hf, especially Hf;
each X is independently a sigma-ligand, such as H, halogen, C₁₋₂₀-alkyl, C₁₋₂₀-alkoxy, C₂-C₂₀-alkenyl, C₂-C₂₀-alkynyl, C3-C12-cycloalkyl, C6-C₂₀-aryl, C6-C₂₀-aryloxy, C7-C₂₀-arylalkyl, C7-C20-arylalkenyl, —SR″, —PR″₃, —SiR″₃, —OSiR″₃, —NR″₂ or —CH₂—Y, wherein Y is C6-C20-aryl, C6-C20-heteroaryl, C₁-C₂₀-alkoxy, C6-C20-aryloxy, NR″₂, —SR″, —PR″₃, —SiR″₃, or —OSiR″₃;
each of the above mentioned ring moieties alone or as a part of another moiety as the substituent for Cp, X, R″ or R1 can further be substituted e.g. with C₁-C₂₀-alkyl which may contain Si and/or O atoms;
n is 0, 1 or 2, e.g. 0 or 1,
m is 1, 2 or 3, e.g. 1 or 2,
q is 1, 2 or 3, e.g. 2 or 3,
   wherein m+q is equal to the valency of M.

Suitably, in each X as —CH₂—Y, each Y is independently selected from C₆-C₂₀-aryl, NR″₂, —SiR″₃ or —OSiR″₃. Most preferably, X as —CH₂—Y is benzyl. Each X other than —CH₂—Y is independently halogen, C1-C20-alkyl, C1-C20-alkoxy, C6-C20-aryl, C7-C20-arylalkenyl or —NR″₂ as defined above, e.g. —N(C1-C20-alkyl)₂.

Preferably, q is 2, each X is halogen or —CH₂—Y, and each Y is independently as defined above.

Cp is preferably cyclopentadienyl, indenyl, tetrahydroindenyl or fluorenyl, optionally substituted as defined above.

In a suitable subgroup of the compounds of formula II, each Cp independently bears 1, 2, 3 or 4 substituents as defined above, preferably 1, 2 or 3, such as 1 or 2 substituents, which are preferably selected from C1-C20-alkyl, C6-C20-aryl, C7-C20-arylalkyl (wherein the aryl ring alone or as a part of a further moiety may further be substituted as indicated above), —OSiR″₃, wherein R″ is as indicated above, preferably C1-C20-alkyl.

R, if present, is preferably a methylene, ethylene or a silyl bridge, whereby the silyl can be substituted as defined above, e.g. a (dimethyl)Si═, (methylphenyl)Si═ or (trimethylsilylmethyl)Si═; n is 0 or 1; m is 2 and q is two. Preferably, R″ is other than hydrogen.

A specific subgroup includes the well known metallocenes of Zr, Hf and Ti with two η-5-ligands which may be bridged or unbridged cyclopentadienyl ligands optionally substituted with e.g. siloxy, or alkyl (e.g. C1-6-alkyl) as defined above, or with two unbridged or bridged indenyl ligands optionally substituted in any of the ring moieties with e.g. siloxy or alkyl as defined above, e.g. at 2-, 3-, 4- and/or 7-positions. Preferred bridges are ethylene or —SiMe₂.

The preparation of the metallocenes can be carried out according or analogously to the methods known from the literature and is within skills of a person skilled in the field. Thus for the preparation see e.g. EP-A-129 368, examples of compounds wherein the metal atom bears a —NR″₂ ligand see i.a. in WO-A-9856831 and WO-A-0034341. For the preparation see also e.g. in EP-A-260 130, WO-A-9728170, WO-A-9846616, WO-A-9849208, WO-A-9912981, WO-A-9919335, WO-A-9856831, WO-A-00/34341, EP-A-423 101 and EP-A-537 130.

Alternatively, in a further subgroup of the metallocene compounds, the metal bears a Cp group as defined above and additionally a η1 or η2 ligand, wherein said ligands may or may not be bridged to each other. Such compounds are described e.g. in WO-A-9613529, the contents of which are incorporated herein by reference.

Further preferred metallocenes include those of formula (I)

Cp′₂M′X′₂

wherein each X′ is halogen, C₁₋₆ alkyl, benzyl or hydrogen;
M′ is Hf or Zr;
Cp′ is a cyclopentadienyl or indenyl group optionally substituted by a C₁₋₁₀ hydrocarbyl group or groups and being optionally bridged, e.g. via an ethylene or dimethylsilyl link.

Especially preferred catalysts are bis-(n-butyl cyclopentadienyl) hafnium dibenzyl, and bis-(n-butyl cyclopentadienyl) zirconium dichloride.

Metallocene procatalysts are generally used as part of a catalyst system which also includes a catalyst activator, called also as cocatalyst. Useful activators are, among others, aluminium compounds, like aluminium alkoxy compounds. Suitable aluminium alkoxy activators are for example methylaluminoxane (MAO), hexaisobutylaluminoxane and tetraisobutylaluminoxane. In addition boron compounds (e.g. a fluoroboron compound such as triphenylpentafluoroboron or triphentylcarbenium tetraphenylpentafluoroborate ((C₆H₅)₃B+B−(C₆F₅)₄)) can be used as activators. The cocatalysts and activators and the preparation of such catalyst systems is well known in the field. For instance, when an aluminium alkoxy compound is used as an activator, the Al/M molar ratio of the catalyst system (Al is the aluminium from the activator and M is the transition metal from the transition metal complex) is suitable from 50 to 500 mol/mol, preferably from 100 to 400 mol/mol. Ratios below or above said ranges are also possible, but the above ranges are often the most useful.

If desired the procatalyst, procatalyst/cocatalyst mixture or a procatalyst/cocatalyst reaction product may be used in supported form (e.g. on a silica or alumina carrier), unsupported form or it may be precipitated and used as such. One feasible way for producing the catalyst system is based on the emulsion technology, wherein no external support is used, but the solid catalyst is formed from by solidification of catalyst droplets dispersed in a continuous phase. The solidification method and further feasible metallocenes are described e.g. in WO03/051934 which is incorporated herein as a reference.

It is also possible to use combinations of different activators and procatalysts. In addition additives and modifiers and the like can be used, as is known in the art.

Any catalytically active catalyst system including the procatalyst, e.g. metallocene complex, is referred herein as single site or metallocene catalyst (system). Processes for making these polymers are well known.

The LLDPE is a commercial product and can be purchased from various suppliers.

### High Density Polyethylene (HDPE)

The HDPE as the polyolefin (A) may be unimodal or multimodal. The polymer is one having a density of at least 940 kg/m³.

The term “multimodal” means herein, unless otherwise stated, multimodality with respect to molecular weight distribution and includes therefore a bimodal polymer. Usually, a polyethylene composition, comprising at least two polyethylene fractions, which have been produced under different polymerization conditions resulting in different (weight average) molecular weights and molecular weight distributions for the fractions, is referred to as “multimodal”. The prefix “multi” relates to the number of different polymer fractions present in the polymer. Thus, for example, multimodal polymer includes so called “bimodal” polymer consisting of two fractions. The form of the molecular weight distribution curve, i.e. the appearance of the graph of the polymer weight fraction as a function of its molecular weight, of a multimodal polymer will show two or more maxima or is typically distinctly broadened in comparison with the curves for the individual fractions. For example, if a polymer is produced in a sequential multistage process, utilizing reactors coupled in series and using different conditions in each reactor, the polymer fractions produced in the different reactors will each have their own molecular weight distribution and weight average molecular weight. When the molecular weight distribution curve of such a polymer is recorded, the individual curves from these fractions form typically together a broadened molecular weight distribution curve for the total resulting polymer product.

A unimodal polymer, unless otherwise stated, is unimodal with respect to molecular weight distribution and therefore contains a single peak on is GPC curve. The HDPE is preferably unimodal.

The HDPE preferably has a density according to ISO 1183 at 23° C. of at least 940 kg/m³, preferably at least 945 kg/m³. The upper limit for density may by 980 kg/m³, preferably 975 kg/m³, especially 970 kg/m³. A highly preferred density range is 945 to 965 kg/m³, such as 954 to 965 kg/m³.

The MFR 2 according to ISO 1133 of the HDPE is preferably in the range of 0.1 to 40 g/10 min, preferably 2 to 35 g/10 min. Preferably the HDPE has an MFR 2 of 3 to 20 g/10 min. An especially preferred range is 5 to 15 g/10 min.

In another embodiment, the HDPE may have an MFR₂₁ according to ISO 1133 of the HDPE is preferably in the range of 8 to 30 g/10 min, preferably 10 to 20 g/10 min.

In some embodiments of the invention, the HDPE may be a multimodal polyethylene comprising at least (i) a lower weight average molecular weight (LMW) ethylene homopolymer or copolymer component, and (ii) a higher weight average molecular weight (HMW) ethylene homopolymer or copolymer component. Preferably, at least one of said LMW and BMW components is a copolymer of ethylene with at least one comonomer. It is preferred that at least said HMW component is an ethylene copolymer. Alternatively, if one of said components is a homopolymer, then said LMW is the preferably the homopolymer.

Said LMW component of multimodal polymer preferably has a MFR₂ of at least 5 g/10 min, preferably at least 50 g/10 min, more preferably at least 100 g/10 min.

The density of LMW component of said multimodal polymer may range from 950 to 980 kg/m³, e.g. 950 to 970 kg/m³.

The LMW component of said multimodal polymer may form from 30 to 70 wt %, e.g. 40 to 60% by weight of the multimodal polymer with the HMW component forming 70 to 30 wt %, e.g. 60 to 40% by weight. In one embodiment said LMW component forms 50 wt % or more of the multimodal polymer as defined above or below. Typically, the LMW component forms 45 to 55% and the HMW component forms 55 to 45% of the multimodal polymer.

The HMW component of said HDPE has a lower MFR 2 than the LMW component. It is however preferred if the HDPE is unimodal.

The HDPE may be an ethylene homopolymer or copolymer. By ethylene homopolymer is meant a polymer which is formed essentially only ethylene monomer units, i.e. is 99.9 wt % ethylene or more. It will be appreciated that minor traces of other monomers may be present due to industrial ethylene containing trace amounts of other monomers.

The HDPE may also be a copolymer (and is preferably a copolymer) and can therefore be formed from ethylene with at least one other comonomer, e.g. C₃₋₂₀ olefin. Preferred comonomers are alpha-olefins, especially with 3-8 carbon atoms. Preferably, the comonomer is selected from the group consisting of propene, 1-butene, 1-hexene, 4-methyl-1-pentene, 1-octene, 1,7-octadiene and 7-methyl-1,6-octadiene. The use of 1-hexene or 1-butene is most preferred.

The HDPE can comprise one monomer or two monomers or more than 2 monomers. The use of a single comonomer is preferred. If two comonomers are used it is preferred if one is an C₃₋₈ alpha-olefin and the other is a diene as hereinbefore defined.

The amount of comonomer is preferably such that it comprises 0-3 mol %, more preferably 0.1-2.0 mol % and most preferably 0.1-1.5 mol % of the HDPE. Values under 1.0 mol % are also envisaged, e.g. 0.1 to 1.0 mol %. These can be determined by NMR.

It is preferred however if the ethylene polymer of the invention comprises a LMW homopolymer component and a HMW ethylene copolymer component, e.g. an ethylene hexene copolymer or an ethylene butene copolymer.

For the preparation of the HDPE polymerisation methods well known to the skilled person may be used. It is within the scope of the invention for a multimodal, e.g. at least bimodal, polymers to be produced by blending each of the components in-situ during the polymerisation process thereof (so called in-situ process) or, alternatively, by blending mechanically two or more separately produced components in a manner known in the art.

Polyethylenes useful in the present invention is preferably obtained by in-situ blending in a multistage polymerisation process. Accordingly, polymers are obtained by in-situ blending in a multistage, i.e. two or more stage, polymerization process including solution, slurry and gas phase process, in any order. Whilst it is possible to use different single site catalysts in each stage of the process, it is preferred if the catalyst employed is the same in both stages.

Ideally therefore, the HDPE used in the invention are produced in at least two-stage polymerization using a single site catalyst or Ziegler Natta catalyst. Thus, for example two slurry reactors or two gas phase reactors, or any combinations thereof, in any order can be employed. Preferably however, the polyethylene is made using a slurry polymerization in a loop reactor followed by a gas phase polymerization in a gas phase reactor.

A loop reactor—gas phase reactor system is well known as Borealis technology, i.e. as a BORSTAR™ reactor system. Such a multistage process is disclosed e.g. in EP517868.

The conditions used in such a process are well known. For slurry reactors, the reaction temperature will generally be in the range 60 to 110° C., e.g. 85-110° C., the reactor pressure will generally be in the range 5 to 80 bar, e.g. 50-65 bar, and the residence time will generally be in the range 0.3 to 5 hours, e.g. 0.5 to 2 hours. The diluent used will generally be an aliphatic hydrocarbon having a boiling point in the range −70 to +100° C., e.g. propane. In such reactors, polymerization may if desired be effected under supercritical conditions. Slurry polymerisation may also be carried out in bulk where the reaction medium is formed from the monomer being polymerised.

For gas phase reactors, the reaction temperature used will generally be in the range 60 to 115° C., e.g. 70 to 110° C., the reactor pressure will generally be in the range 10 to 25 bar, and the residence time will generally be 1 to 8 hours. The gas used will commonly be a non-reactive gas such as nitrogen or low boiling point hydrocarbons such as propane together with monomer, e.g. ethylene.

The ethylene concentration in the first, preferably loop, reactor may be around 5 to 15 mol %, e.g. 7.5 to 12 mol %.

In the second, preferably gas phase, reactor, ethylene concentration is preferably much higher, e.g. at least 40 mol % such as 45 to 65 mol %, preferably 50 to 60 mol %.

Preferably, the first polymer fraction is produced in a continuously operating loop reactor where ethylene is polymerised in the presence of a polymerization catalyst as stated above and a chain transfer agent such as hydrogen. The diluent is typically an inert aliphatic hydrocarbon, preferably isobutane or propane. The reaction product is then transferred, preferably to continuously operating gas phase reactor. The second component can then be formed in a gas phase reactor using preferably the same catalyst.

The HDPE is a commercial product and can be purchased from various suppliers.

### Polystyrene

The polystyrene is a polymer comprising styrene monomers, preferably only styrene monomers.

The density of the polystyrene is typically at least 0.1 g/mL when measured at 25° C., preferably at least 0.5 g/mL.

The polystyrene may have an Mw of 10 kg/mol to 200 kg/mol, such as 20 to 100 kg/mol.

In one embodiment the polystyrene is not a styrene block copolymer.

The polystyrene is a commercial product and can be purchased from various suppliers.

### Polybutadiene

The polybutadiene is a polymer comprising butadiene monomers. Thus, the polybutadiene is an unsaturated polymer.

The polybutadiene preferably has a total amount of vinyl groups higher than 0.05/1000 carbon atoms, still more preferably higher than 0.1/1000 carbon atoms, and most preferably of higher than 0.2/1000 carbon atoms. Preferably, the total amount of vinyl groups is of lower than 4.0/1000 carbon atoms, more preferably lower than 2.0/1000 carbon atoms.

The density of the polybutadiene is typically at least 0.1 g/mL when measured at 25° C., preferably at least 0.5 g/mL.

The polybutadiene may have an Mw of 100 kg/mol to 400 kg/mol, such as 150 to 300 kg/mol.

The polybutadiene is a commercial product and can be purchased from various suppliers.

It is possible to use a mixture of polyolefins (A). If a mixture of polyolefins (A) is used then the wt % refers to the total content of the polyolefins (A) in the polymer composition.

### Composition

Whilst it is within the ambit of the invention for the polyolefin composition to comprise other polymer components in addition to the LDPE, polypropylene and polyolefin (A), it is preferable if the composition consists of the LDPE, polypropylene and polyolefin (A) as the only polymer components. It will be appreciated that the polymer composition may further contain standard polymer additives discussed in more detail below.

In a preferred embodiment, the invention provides a polymer composition comprising
(i) 25 to 75 wt % LDPE;
(ii) 20 to 70 wt % of a polypropylene; and
(iii) 1.0 to 15 wt % of a polyolefin (A) selected from the group consisting of a linear low density polyethylene (LLDPE), high density polyethylene (HDPE), polystyrene and polybutadiene.

In another preferred embodiment, the invention provides a polymer composition comprising
(i) 50 to 75 wt % LDPE;
(ii) 20 to 50 wt % of a polypropylene; and
(iii) 1.0 to 15 wt % of a polyolefin (A) selected from the group consisting of a linear low density polyethylene (LLDPE), high density polyethylene (HDPE), polystyrene and polybutadiene.

In another preferred embodiment, the invention provides a polymer composition comprising
(i) 60 to 74 wt % LDPE;
(ii) 22 to 40 wt % of a polypropylene; and
(iii) 2.0 to 10 wt % of a polyolefin (A) selected from the group consisting of a linear low density polyethylene (LLDPE), high density polyethylene (HDPE), polystyrene and polybutadiene.

In a further preferred embodiment, the invention provides a polymer composition comprising
(i) 65 to 73 wt % LDPE;
(ii) 23 to 35 wt % of a polypropylene; and
(iii) 3.0 to 8 wt % of a polyolefin (A) selected from the group consisting of a linear low density polyethylene (LLDPE), high density polyethylene (HDPE), polystyrene and polybutadiene.

In any of the above embodiments the use of peroxide with the undesired problems as discussed above can be markedly reduced or completely avoided. Hence, the polymer composition of the invention is preferably substantially free of peroxide (e.g. comprises less than 0.5 wt % peroxide, preferably less than 0.1 wt % peroxide, such as less than 0.05 wt % peroxide, relative to the total weight of the composition). Even more preferably, the polymer composition is free of any added peroxide (i.e. contains 0 wt % peroxide, relative to the total weight of the composition) and most preferably free of any radical forming agent.

In one embodiment, the composition is thermoplastic. Thus, the composition of the invention is preferably not crosslinked.

During manufacture of the composition, the components can be blended and homogenously mixed, e.g. melt mixed in an extruder.

Typically, said process will be carried out by compounding by, for example, extrusion. Preferably, said process does not involve the use of peroxide. Thus, the composition of the invention is substantially free of peroxide (e.g. comprises less than 0.5 wt % peroxide, preferably less than 0.1 wt % peroxide, such as less than 0.05 wt % peroxide, relative to the total weight of the composition) and associated decomposition products. As a result of this the process for preparing the polymer composition of the invention typically does not comprise a degassing step.

Typically, the process involves heating to a temperature of at least 150° C., preferably at least 160° C., such as at least 170° C. The process will generally involve heating to 300° C. or less, such as 250° C. or less.

The storage modulus of the composition of the invention at 50° C. is preferably less than 500 MPa, more preferably less than 400 MPa (as measured by the test method in the test methods section below). A typical lower limit for the storage modulus of the composition at 50° C. is 120 MPa, such as 130 MPa.

The storage modulus of the composition of the invention at 110° C. is preferably more than 10 MPa, more preferably more than 12 MPa (as measured by the test method in the test methods section below). A typical upper limit for the storage modulus of the composition at 110° C. is 100 MPa, such as 50 MPa, for example 25 MPa.

The storage modulus of the composition of the invention at 140° C. is preferably more than 0.1 MPa, more preferably more than 0.2 MPa (as measured by the test method in the test methods section below). A typical upper limit for the storage modulus of the composition at 140° C. is 30 MPa, such as 15 MPa.

### Cable

The cable of the invention is typically a power cable, such as an AC cable or a DC cable. A power cable is defined to be a cable transferring energy operating at any voltage level, typically operating at voltages higher than 1 kV. The power cable can be a low voltage (LV), a medium voltage (MV), a high voltage (HV) or an extra high voltage (EHV) cable, which terms, as well known, indicate the level of operating voltage.

The polymer composition is even more preferably used in the insulation layer for a DC power cable operating at voltages higher than 36 kV, such as a HV DC cable. For HV DC cables the operating voltage is defined herein as the electric voltage between ground and the conductor of the high voltage cable.

Preferably the HV DC power cable of the invention is one operating at voltages of 40 kV or higher, even at voltages of 50 kV or higher. More preferably, the HV DC power cable operates at voltages of 60 kV or higher. The invention is also highly feasible in very demanding cable applications and further cables of the invention are HV DC power cable operating at voltages higher than 70 kV. Voltages of 100 kV or more are targeted, such as 200 kV or more, more preferably 300 kV or more, especially 400 kV or more, more especially 500 kV or more. Voltages of 640 kV or more, such as 700 kV are also envisaged. The upper limit is not limited. The practical upper limit can be up to 1500 kV, such as 1100 kV. The cables of the invention operate well therefore in demanding extra HV DC power cable applications operating 400 to 850 kV, such as 650 to 850 kV.

A cable, such as a power cable (e.g. a DC power cable) comprises one or more conductors surrounded by at least one layer. The polymer composition of the invention may be used in that at least one layer. Preferably, the cable comprises an inner semiconductive layer, an insulation layer and an outer semiconductive layer, in that order.

The polymer composition of the invention may be used in the insulation layer or semiconductive layer of the cable, however it is preferably used in the insulation layer. Ideally, the insulation layer comprises at least 95 wt %, such as at least 98 wt % of the polymer composition of the invention, such as at least 99 wt %, relative to the total weight of the layer as a whole. It is preferred therefore if the polymer composition of the invention is the only non-additive component used in the insulation layer of the cables of the invention. Thus, it is preferred if the insulation layer consists essentially of the composition of the invention. The term consists essentially of is used herein to mean that the only polymer composition present is that defined herein. It will be appreciated that the insulation layer may contain standard polymer additives such as water tree retarders, antioxidants and so on. These are not excluded by the term “consists essentially of”. Note also that these additives may be added as part of a masterbatch and hence carried on a polymer carrier. The use of masterbatch additives is not excluded by the term consists essentially of.

The insulation layer is preferably not cross-linked. It is preferred if the insulation layer comprises no crosslinking agent. The insulation layer is thus ideally free of peroxides and hence free of by-products of the decomposition of the peroxide.

Naturally, the non cross-linked embodiment also simplifies the cable production process. Also, it is generally required to degas a cross-linked cable layer to remove the by-products of these agents after crosslinking. Where these are absent, no such degassing step is required. Another advantage of not using an external crosslinking agent is the elimination of the health and safety issues associated with the handling and storage of these agents, particularly peroxides.

The insulation layer may contain, in addition to the polymer composition of the invention further component(s) such as additives, e.g. antioxidant(s), scorch retarder(s) (SR), crosslinking booster(s), stabiliser(s), processing aid(s), flame retardant additive(s), water tree retardant additive(s), acid or ion scavenger(s), inorganic filler(s), dielectric liquids and voltage stabilizer(s), as known in the polymer field. Typically, however, no scorch retarder will be present.

The insulation layer may therefore comprise conventionally used additive(s) for W&C applications, such as one or more antioxidant(s). As non-limiting examples of antioxidants e.g. sterically hindered or semi-hindered phenols, aromatic amines, aliphatic sterically hindered amines, organic phosphites or phosphonites, thio compounds, and mixtures thereof, can be mentioned.

Preferably, the insulation layer does not comprise a carbon black. Also preferably, the insulation layer does not comprise flame retarding additive(s), e.g. a metal hydroxide containing additives in flame retarding amounts.

The used amounts of additives are conventional and well known to a skilled person, e.g. 0.1 to 1.0 wt %.

The cable of the invention also typically contains inner and outer semiconductive layers. These can be made of any conventional material suitable for use in these layers. The inner and the outer semiconductive compositions can be different or identical and may comprise a polymer(s) which is preferably a polyolefin or a mixture of polyolefins and a conductive filler, preferably carbon black. As discussed above, it is possible to use the polymer composition of the invention in one or both of the semiconductive layers. Other suitable polyolefin(s) are e.g. polyethylene produced in a low pressure process (LLDPE, MDPE, HDPE), polyethylene produced in a HP process (LDPE) or a polypropylene. The carbon black can be any conventional carbon black used in the semiconductive layers of a power cable, preferably in the semiconductive layer of a power cable. Preferably the carbon black has one or more of the following properties: a) a primary particle size of at least 5 nm which is defined as the number average particle diameter according ASTM D3849-95a, dispersion procedure D b) iodine number of at least 30 mg/g according to ASTM D1510, c) oil absorption number of at least 30 ml/100 g which is measured according to ASTM D2414. Non-limiting examples of carbon blacks are e.g. acetylene carbon black, furnace carbon black and Ketjen carbon black, preferably furnace carbon black and acetylene carbon black. Preferably, the polymer composition of the semiconductive layer(s) comprises 10 to 50 wt % carbon black, based on the total weight of the composition.

In a preferable embodiment, the outer semiconductive layer is non-cross-linked. In another preferred embodiment, the inner semiconductive layer is preferably non-cross-linked. Overall therefore it is preferred if the inner semiconductive layer, the insulation layer and the outer semiconductive layer are non-cross-linked.

The conductor typically comprises one or more wires. Moreover, the cable may comprise one or more such conductors. Preferably the conductor is an electrical conductor and comprises one or more metal wires. Cu or Al wire is preferred.

As well known the cable can optionally comprise further layers, e.g. screen(s), a jacketing layer(s), other protective layer(s) or any combinations thereof.

### Cable Manufacture

The invention also provides a process for producing a cable comprising the steps of applying on one or more conductors, preferably by (co)extrusion, a layer comprising the polymer composition of the invention.

The invention also provides a process for producing a cable comprising the steps of applying on one or more conductors, preferably by (co)extrusion, an inner semiconductive layer, an insulation layer and an outer semiconductive layer, in that order, wherein the insulation layer comprises the composition of the invention.

The invention also provides a process for producing a cable comprising the steps of
applying on one or more conductors, preferably by (co)extrusion, an inner semiconductive layer, an insulation layer and an outer semiconductive layer, in that order, wherein the insulation layer comprises the composition of the invention.

The process may optionally comprise the steps of crosslinking one or both of the inner semiconductive layer or outer semiconductive layer, without crosslinking the insulation layer.

More preferably, a cable is produced, wherein the process comprises the steps of
(a)—providing and mixing, preferably melt mixing in an extruder, an optionally crosslinkable first semiconductive composition comprising a polymer, a carbon black and optionally further component(s) for the inner semiconductive layer,
   providing and mixing, preferably melt mixing in an extruder, the polymer composition of the invention; and
   providing and mixing, preferably melt mixing in an extruder, a second semiconductive composition which is optionally crosslinkable and comprises a polymer, a carbon black and optionally further component(s) for the outer semiconductive layer,
(b) applying on one or more conductors, preferably by coextrusion,
   a melt mix of the first semiconductive composition obtained from step (a) to form the inner semiconductive layer,
   a meltmix of polymer composition of the invention obtained from step (a) to form the insulation layer, and
   a meltmix of the second semiconductive composition obtained from step (a) to form the outer semiconductive layer, and
(c) optionally crosslinking at crosslinking conditions one or both of the first semiconductive composition of the inner semiconductive layer and the second semiconductive composition of the outer semiconductive layer, of the obtained cable, without crosslinking the insulation layer.

Melt mixing means mixing above the melting point of at least the major polymer component(s) of the obtained mixture and is carried out for example, without limiting to, in a temperature of at least 15° C. above the melting or softening point of polymer component(s).

The term “(co)extrusion” means herein that in case of two or more layers, said layers can be extruded in separate steps, or at least two or all of said layers can be coextruded in a same extrusion step, as well known in the art. The term “(co)extrusion” means herein also that all or part of the layer(s) are formed simultaneously using one or more extrusion heads. For instance a triple extrusion can be used for forming three layers. In case a layer is formed using more than one extrusion heads, then for instance, the layers can be extruded using two extrusion heads, the first one for forming the inner semiconductive layer and the inner part of the insulation layer, and the second head for forming the outer insulation layer and the outer semiconductive layer.

As well known, the polymer composition of the invention and the optional and preferred first and second semiconductive compositions can be produced before or during the cable production process.

Preferably, the polymers required to manufacture the cable of the invention are provided to the cable production process in form of powder, grain or pellets. Pellets mean herein generally any polymer product which is formed from reactor-made polymer (obtained directly from the reactor) by post-reactor modification to a solid polymer particles.

Accordingly, the components can be premixed, e.g. melt mixed together and pelletized, before mixing. Alternatively, and preferably, these components can be provided in separate pellets to the (melt) mixing step (a), where the pellets are blended together.

The (melt) mixing step (a) of the provided polymer composition of the invention and of the preferable first and second semiconductive compositions is preferably carried out in a cable extruder. The step a) of the cable production process may optionally comprise a separate mixing step, e.g. in a mixer arranged in connection and preceding the cable extruder of the cable production line. Mixing in the preceding separate mixer can be carried out by mixing with or without external heating (heating with an external source) of the component(s).

Any crosslinking agent can be added before the cable production process or during the (melt) mixing step (a). For instance, and preferably, the crosslinking agent and also the optional further component(s), such as additive(s), can already be present in the polymers used. The crosslinking agent is added, preferably impregnated, onto the solid polymer particles, preferably pellets.

It is preferred that the melt mix of the polymer composition obtained from (melt)mixing step (a) consists of the LDPE (i), polypropylene (ii) and polyolefin (A) (iii) as the sole polymer components. The optional and preferable additive(s) can be added to polymer composition as such or as a mixture with a carrier polymer, i.e. in a form of a master batch.

The crosslinking of other layers can be carried out at increased temperature which is chosen, as well known, depending on the type of crosslinking agent. For instance temperatures above 150° C., such as from 160 to 350° C., are typical, however without limiting thereto.

The processing temperatures and devices are well known in the art, e.g. conventional mixers and extruders, such as single or twin screw extruders, are suitable for the process of the invention.

The thickness of the insulation layer of the cable, more preferably of the power cable is typically 2 mm or more, preferably at least 3 mm, preferably of at least 5 to 100 mm, more preferably from 5 to 50 mm, and conventionally 5 to 40 mm, e.g. 5 to 35 mm, when measured from a cross section of the insulation layer of the cable.

The thickness of the inner and outer semiconductive layers is typically less than that of the insulation layer, and in power cables can be e.g. more than 0.1 mm, such as from 0.3 up to 20 mm, 0.3 to 10 of inner semiconductive and outer semiconductive layer. The thickness of the inner semiconductive layer is preferably 0.3-5.0 mm, preferably 0.5-3.0 mm, preferably 0.8-2.0 mm. The thickness of the outer semiconductive layer is preferably from 0.3 to 10 mm, such as 0.3 to 5 mm, preferably 0.5 to 3.0 mm, preferably 0.8-3.0 mm. It is evident for and within the skills of a skilled person that the thickness of the layers of the power cable depends on the intended voltage level of the end application cable and can be chosen accordingly.

The cable of the invention is preferably a power cable, preferably a power cable operating at voltages up to 1 kV and known as low voltage (LV) cables, at voltages 1 kV to 36 kV and known as medium voltage (MV) cables, at voltages higher than 36 kV, known as high voltage (HV) cables or extra high voltage (EHV) cables. The terms have well known meanings and indicate the operating level of such cables.

More preferably the cable is a power cable comprising a conductor surrounded by at least an inner semiconductive layer, an insulation layer and an outer semiconductive layer, in that order, wherein at least one layer comprises, preferably consists of, the polyolefin composition of the invention.

Preferably, the at least one layer is the insulation layer.

In a further embodiment, the invention provides the use of a polyolefin composition as hereinbefore defined in the manufacture of a layer, preferably an insulation layer, of a cable.

Such cable embodiment enables to crosslink the cable without using peroxide which is very beneficial in view of the problems caused by using peroxide as discussed above.

### DESCRIPTION OF FIGS

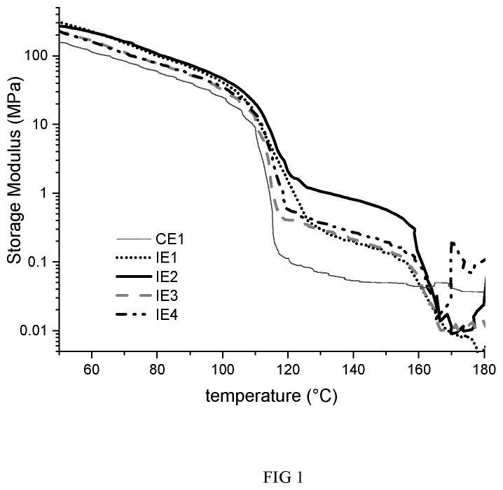

FIG. 1: Storage modulus vs. Temperature measured using DMTA for CE1 and IE1-IE4.

### EXAMPLES

### Determination Methods

Unless otherwise stated in the description or claims, the following methods were used to measure the properties defined generally above and in the claims and in the examples below. The samples were prepared according to given standards, unless otherwise stated.

Wt %: % by weight

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene and at 230° C. for polypropylene. MFR may be determined at different loadings such as 2.16 kg (MFR₂) or 21.6 kg (MFR₂₁).

### Molecular Weight

Mz, Mw, Mn, and MWD are measured by Gel Permeation Chromatography (GPC) according to the following method:

The weight average molecular weight Mw and the molecular weight distribution (MWD=Mw/Mn wherein Mn is the number average molecular weight and Mw is the weight average molecular weight; Mz is the z-average molecular weight) is measured according to ISO 16014-4:2003 and ASTM D 6474-99. A Waters GPCV2000 instrument, equipped with refractive index detector and online viscosimeter was used with 2×GMHXL-HT and 1×G7000HXL-HT TSK-gel columns from Tosoh Bioscience and 1,2,4-trichlorobenzene (TCB, stabilized with 250 mg/L 2,6-Di tert-butyl-4-methyl-phenol) as solvent at 140° C. and at a constant flow rate of 1 mL/min. 209.5 μL of sample solution were injected per analysis. The column set was calibrated using universal calibration (according to ISO 16014-2:2003) with at least 15 narrow MWD polystyrene (PS) standards in the range of 1 kg/mol to 12 000 kg/mol. Mark Houwink constants were used as given in ASTM D 6474-99. All samples were prepared by dissolving 0.5-4.0 mg of polymer in 4 mL (at 140° C.) of stabilized TCB (same as mobile phase) and keeping for max. 3 hours at a maximum temperature of 160° C. with continuous gentle shaking prior sampling in into the GPC instrument.

### Comonomer Contents

a) Comonomer Content in Random Copolymer of Polypropylene:

Quantitative Fourier transform infrared (FTIR) spectroscopy was used to quantify the amount of comonomer. Calibration was achieved by correlation to comonomer contents determined by quantitative nuclear magnetic resonance (NMR) spectroscopy.

The calibration procedure based on results obtained from quantitative 13C-NMR spectroscopy was undertaken in the conventional manner well documented in the literature.

The amount of comonomer (N) was determined as weight percent (wt %) via:

N=k1(A/R)+k2

wherein A is the maximum absorbance defined of the comonomer band, R the maximum absorbance defined as peak height of the reference peak and with k1 and k2 the linear constants obtained by calibration. The band used for ethylene content quantification is selected depending if the ethylene content is random (730 cm⁻¹) or block-like (as in heterophasic PP copolymer) (720 cm⁻¹). The absorbance at 4324 cm⁻¹ was used as a reference band.

b) Quantification of Alpha-Olefin Content in Linear Low Density Polyethylenes and Low Density Polyethylenes by NMR Spectroscopy:

The comonomer content was determined by quantitative 13C nuclear magnetic resonance (NMR) spectroscopy after basic assignment (J. Randall JMS—Rev. Macromol. Chem. Phys., C29(2&3), 201-317 (1989). Experimental parameters were adjusted to ensure measurement of quantitative spectra for this specific task.

Specifically solution-state NMR spectroscopy was employed using a Bruker Avancelll 400 spectrometer. Homogeneous samples were prepared by dissolving approximately 0.200 g of polymer in 2.5 ml of deuterated-tetrachloroethene in 10 mm sample tubes utilising a heat block and rotating tube oven at 140 C. Proton decoupled 13C single pulse NMR spectra with NOE (powergated) were recorded using the following acquisition parameters: a flip-angle of 90 degrees, 4 dummy scans, 4096 transients an acquisition time of 1.6 s, a spectral width of 20 kHz, a temperature of 125 C, a bilevel WALTZ proton decoupling scheme and a relaxation delay of 3.0 s. The resulting FID was processed using the following processing parameters: zero-filling to 32 k data points and apodisation using a gaussian window function; automatic zeroth and first order phase correction and automatic baseline correction using a fifth order polynomial restricted to the region of interest.

Quantities were calculated using simple corrected ratios of the signal integrals of representative sites based upon methods well known in the art.

c) Comonomer Content of Polar Comonomers in Low Density Polyethylene

(1) Polymers Containing>6 wt % Polar Comonomer Units

Comonomer content (wt %) was determined in a known manner based on Fourier transform infrared spectroscopy (FTIR) determination calibrated with quantitative nuclear magnetic resonance (NMR) spectroscopy. Below is exemplified the determination of the polar comonomer content of ethylene ethyl acrylate, ethylene butyl acrylate and ethylene methyl acrylate. Film samples of the polymers were prepared for the FTIR measurement: 0.5-0.7 mm thickness was used for ethylene butyl acrylate and ethylene ethyl acrylate and 0.10 mm film thickness for ethylene methyl acrylate in amount of >6 wt %. Films were pressed using a Specac film press at 150° C., approximately at 5 tons, 1-2 minutes, and then cooled with cold water in a not controlled manner. The accurate thickness of the obtained film samples was measured.

After the analysis with FTIR, base lines in absorbance mode were drawn for the peaks to be analysed. The absorbance peak for the comonomer was normalised with the absorbance peak of polyethylene (e.g. the peak height for butyl acrylate or ethyl acrylate at 3450 cm⁻¹ was divided with the peak height of polyethylene at 2020 cm⁻¹). The NMR spectroscopy calibration procedure was undertaken in the conventional manner which is well documented in the literature, explained below.

For the determination of the content of methyl acrylate a 0.10 mm thick film sample was prepared. After the analysis the maximum absorbance for the peak for the methylacrylate at 3455 cm⁻¹ was subtracted with the absorbance value for the base line at 2475 cm⁻¹ (A_{methylacrylate}−A₂₄₇₅). Then the maximum absorbance peak for the polyethylene peak at 2660 cm⁻¹ was subtracted with the absorbance value for the base line at 2475 cm⁻¹ (A₂₆₆₀−A₂₄₇₅). The ratio between (A_{methylacrylate}−A₂₄₇₅) and (A₂₆₆₀−A₂₄₇₅) was then calculated in the conventional manner which is well documented in the literature.

The weight-% can be converted to mol-% by calculation. It is well documented in the literature.

Quantification of Copolymer Content in Polymers by NMR Spectroscopy

The comonomer content was determined by quantitative nuclear magnetic resonance (NMR) spectroscopy after basic assignment (e.g. “NMR Spectra of Polymers and Polymer Additives”, A. J. Brandolini and D. D. Hills, 2000, Marcel Dekker, Inc. New York). Experimental parameters were adjusted to ensure measurement of quantitative spectra for this specific task (e.g “200 and More NMR Experiments: A Practical Course”, S. Berger and S. Braun, 2004, Wiley-VCH, Weinheim). Quantities were calculated using simple corrected ratios of the signal integrals of representative sites in a manner known in the art.

(2) Polymers Containing 6 wt. % or Less Polar Comonomer Units

Comonomer content (wt. %) was determined in a known manner based on Fourier transform infrared spectroscopy (FTIR) determination calibrated with quantitative nuclear magnetic resonance (NMR) spectroscopy. Below is exemplified the determination of the polar comonomer content of ethylene butyl acrylate and ethylene methyl acrylate. For the FT-IR measurement a film samples of 0.05 to 0.12 mm thickness were prepared as described above under method 1). The accurate thickness of the obtained film samples was measured.

After the analysis with FT-IR base lines in absorbance mode were drawn for the peaks to be analysed. The maximum absorbance for the peak for the comonomer (e.g. for methylacrylate at 1164 cm⁻¹ and butylacrylate at 1165 cm⁻¹) was subtracted with the absorbance value for the base line at 1850 cm⁻¹ (A_{polar comonomer}−A₁₈₅₀). Then the maximum absorbance peak for polyethylene peak at 2660 cm⁻¹ was subtracted with the absorbance value for the base line at 1850 cm⁻¹ (A₂₆₆₀−A₁₈₅₀). The ratio between (A_{comonomer}−A₁₈₅₀) and (A₂₆₆₀−A₁₈₅₀) was then calculated. The NNW spectroscopy calibration procedure was undertaken in the conventional manner which is well documented in the literature, as described above under method 1).

The weight-% can be converted to mol-% by calculation. It is well documented in the literature.

Below is exemplified how polar comonomer content obtained from the above method (1) or (2), depending on the amount thereof, can be converted to micromol or mmol per g polar comonomer as used in the definitions in the text and claims:

The millimoles (mmol) and the micro mole calculations have been done as described below.

For example, if 1 g of the poly(ethylene-co-butylacrylate) polymer, which contains 20 wt % butylacrylate, then this material contains 0.20/M_{butylacrylate} (128 g/mol)=1.56×10⁻³ mol. (=1563 micromoles).

The content of polar comonomer units in the polar copolymer C_{polar comonomer} is expressed in mmol/g (copolymer). For example, a polar poly(ethylene-co-butylacrylate) polymer which contains 20 wt. % butyl acrylate comonomer units has a C_{polar comonomer} of 1.56 mmol/g.

The used molecular weights are: M_{butylacrylate}=128 g/mole, M_{ethylacrylate}=100 g/mole, M_{methylacrylate}=86 g/mole).

### Density

Low density polyethylene (LDPE): The density was measured according to ISO 1183-2. The sample preparation was executed according to ISO 1872-2 Table 3 Q (compression moulding).

Density of the PP polymer was measured according to ISO 1183/1872-2B.

### Method for Determination of the Amount of Double Bonds in the Polymer Composition or in the Polymer

This can be carried out following the protocol in WO2011/057928

### Melting Temperature

Melting Temperature™, is measured with Mettler TA820 differential scanning calorimetry (DSC) on 5-10 mg samples. Melting curves are obtained during 10° C./min cooling and heating scans between 30° C. and 225° C. Melting temperatures were taken as the peaks of endotherms and exotherms.

### Storage Modulus

Storage modulus was measured using Dynamic Mechanical Thermal Analysis (DMTA). DMTA was carried out using a TA Q800 DMA in tensile mode on ×5 mm pieces cut from 1.25 mm thick melt-pressed films. Variable-temperature measurements were done at a heating rate of 2° C. min⁻¹, and a frequency of 0.5 Hz.

### Materials

LDPE: LDPE homopolymer with a MFI˜2 g/10 min (190° C./2.16 kg) was obtained from Borealis AB (M_{w˜}117 kg mol⁻¹, PDI˜9, number of long-chain branches˜1.9).

iPP: Isotactic polypropylene with a MFI˜3.3 g/10 min (230° C./2.16 kg) was obtained from Borealis AB (M_{w}˜411 kg mol⁻¹, PDI˜8.5).

HDPE: A unimodal high density polyethylene with a density of 962 kg/m³ and MFR₂ of 12 g/10 min made via Ziegler Natta catalysis with butene comonomers, was obtained from Borealis.

LLDPE: A single site copolymer of ethylene with 1-butene and 1-hexene as comonomers, a MFR₂ of 1.5 g/10 min and density 918 kg/m³ was obtained from Borealis.

PS: Polystyrene with a density of 1.06 g/mL at 25° C. was obtained from Sigma Aldrich (M_{w}˜35 kg mol⁻¹) (product number 331651).

PB: Polybutadiene with 98% cis-1,4, and density of 0.9 g/mL at 25° C. was obtained from Sigma Aldrich (M_{w}˜200-300 kg mol⁻¹) (product number 181374).

### Experimental

### Sample Preparation:

Copolymer formulations were compounded through extrusion for 5 minutes at 180° C. using an Xplore Micro Compounder MCS. The extruded material was heated to 200° C. and pressed up to a pressure of 3750 kPa for 1 minute in a hot press, resulting in 1.25 mm thick plates. Storage modulus results are shown in Table 1 and FIG. 1.

| | CE1 | IE1 | IE2 | IE3 | IE4 |
|---|---|---|---|---|---|
| “LDPE” [weight %] | 75 | 71 | 71 | 71 | 71 |
| “iPP” [weight %] | 25 | 24 | 24 | 24 | 24 |
| “HDPE” [weight %] | | 5 | | | |
| “LLDPE” [weight %] | | | 5 | | |
| “polystyrene” [weight %] | | | | 5 | |
| “polybutadiene” [weight %] | | | | | 5 |
| Compounding temperature [° C.] | 180 | 180 | 180 | 180 | 180 |
| Compounding time [min] | 5 | 5 | 5 | 5 | 5 |
| Plaque press temperature [° C.] | 200 | 200 | 200 | 200 | 200 |
| Press time [min] | 1 | 1 | 1 | 1 | 1 |
| Strain [%] | 1 | 1 | 1 | 1 | 1 |
| Frequency [Hz] | 0.5 | 0.5 | 0.5 | 0.5 | 0.5 |
| Heating rate [° C./min] | 2 | 2 | 2 | 2 | 2 |
| Storage modulus at 50° C. [MPa] | 158 | 304 | 271 | 224 | 227 |
| Storage modulus at 90° C. [MPa] | 40.8 | 67.4 | 72.4 | 52.9 | 53.3 |
| Storage modulus at 110° C. [MPa] | 8.99 | 18.2 | 21.1 | 13.0 | 14.6 |
| Storage modulus at 140° C. [MPa] | 0.0535 | 0.202 | 0.814 | 0.219 | 0.267 |
| Storage modulus at 160° C. [MPa] | 0.0442 | 0.0982 | 0.146 | 0.0635 | 0.0861 |

As can be seen in Table 1, a blend of 25% isotactic PP (iPP) and 75% LDPE (CE1) has relatively poor thermomechanical performance manifested by low storage modulus at elevated temperatures (110, 140 & 160° C.). However, IE1 to IE4 containing 5% of polyolefin (A) (HDPE, LLDPE, PS or PB) have significantly higher storage modulus at elevated temperatures (110, 140 & 160° C.). The improved dimensional stability may offer the possibility to use such blends as electrical insulation for power cables that can operate well above 100° C.

1. A polymer composition comprising:
(i) 25 to 84 wt % LDPE;
(ii) 15 to 74 wt % of a polypropylene; and
(iii) 1.0 to 20 wt % of a polyolefin (A), wherein polyolefin (A) is selected from the group consisting of a linear low density polyethylene (LLDPE), high density polyethylene (HDPE), polystyrene and polybutadiene;
wherein the weight percentages are based on the polymer composition as a whole.

2. The polymer composition as claimed in claim 1, wherein the polymer composition comprises:
(i) 25 to 75 wt % LDPE;
(ii) 20 to 70 wt % of the polypropylene; and
(iii) 1.0 to 15 wt % of the polyolefin (A), wherein polyolefin (A) is selected from the group consisting of a linear low density polyethylene (LLDPE), high density polyethylene (HDPE), polystyrene and polybutadiene.

3. The polymer composition as claimed in claim 1, wherein the polymer composition comprises:
(i) 50 to 75 wt % LDPE;
(ii) 20 to 50 wt % of the polypropylene; and
(iii) 1.0 to 15 wt % of the polyolefin (A), wherein polyolefin (A) is selected from the group consisting of a linear low density polyethylene (LLDPE), high density polyethylene (HDPE), polystyrene and polybutadiene.

4. The polymer composition as claimed in claim 1, wherein the polymer composition comprises:
(i) 60 to 74 wt % LDPE;
(ii) 22 to 40 wt % of the polypropylene; and
(iii) 2.0 to 10 wt % of the polyolefin (A), wherein polyolefin (A) is selected from the group consisting of a linear low density polyethylene (LLDPE), high density polyethylene (HDPE), polystyrene and polybutadiene.

5. The polymer composition as claimed in claim 1, wherein the polypropylene (ii) has a melting point of at least 150° C., when measured according to ISO 11357-3.

6. The polymer composition as claimed in claim 1, wherein the polypropylene (ii) is an isotactic polypropylene homopolymer.

7. The polymer composition as claimed in claim 1, wherein the polyolefin (A) is an LLDPE.

8. The polymer composition as claimed in claim 7, wherein said LLDPE is a copolymer of ethylene with at least one alpha-olefin comonomer.

9. The polymer composition as claimed in claim 1, wherein the LDPE (i) has a density of 915 to 940 kg/m³, as determined in accordance with ISO 1183-2.

10. The polymer composition as claimed in claim 7, wherein the LLDPE has a density of 910 to 925 kg/m³, as determined in accordance with ISO 1183.

11. The polymer composition as claimed in claim 1, wherein the polyolefin (A) is an HDPE and the HDPE has a density of 940 to 980 kg/m³, as determined in accordance with ISO 1183.

12. The polymer composition as claimed in claim 1, wherein said polymer composition has:
a storage modulus of more than 10 MPa at 110° C.,
a storage modulus of less than 500 MPa at 50° C.,
a storage modulus of more than 0.1 MPa at 140° C.,
or a combination thereof,
when measured using Dynamic Mechanical Thermal Analysis according to the method described herein under “Determination methods”.

13. The polymer composition as claimed in claim 1, wherein the polymer composition does not comprise a peroxide.

14. A cable comprising one or more conductors surrounded by at least one layer, wherein said layer comprises the polymer composition as defined in claim 1.

15. The cable as claimed in claim 14, wherein said layer is an insulation layer.

16. The cable as claimed in claim 14, or where said one or more conductors are surrounded by at least an inner semiconductive layer, an insulation layer, and an outer semiconductive layer, in that order.

17. The cable as claimed in claim 15, wherein the insulation layer of said cable is not crosslinked.

18. A process for the preparation of the polymer composition as claimed in claim 1, the process comprising compounding:
(i) 25 to 84 wt % LDPE;
(ii) 15 to 74 wt % of the polypropylene; and
(iii) 1.0 to 20 wt % of the polyolefin (A), wherein polyolefin (A) is selected from the group consisting of a linear low density polyethylene (LLDPE), high density polyethylene (HDPE), polystyrene and polybutadiene.

19. A process for producing a cable comprising the steps of: applying on one or more conductors, a layer comprising a polymer composition as defined in claim 1.

20. A method of use of the polymer composition as defined in claim 1, the method comprising using the polymer composition in the manufacture of an insulation layer in a cable.
